(19) United States
(12) Patent Application Publication
(10) Pub. No.: US 2016/0288703 A1
(43) Pub. Date: Oct. 6, 2016

(54) VEHICLE SIGNALING DEVICE TO INDICATE THE INTENTION TO REVERSE GEAR

(71) Applicant: Reinaldo BERTANHA, Tatui (BR)

(72) Inventor: Reinaldo BERTANHA, Tatui (BR)

(21) Appl. No.: 15/035,340

(22) PCT Filed: Oct. 28, 2014
(86) PCT No.: PCT/IB2014/065660

§ 371 Date: May 9, 2016

(30) Foreign Application Priority Data
Nov. 8, 2013 (BR) 1020130289108

(51) Int. Cl. B60Q 1/48; B60Q 1/22

(52) U.S. Cl. CPC B60Q 1/488; B60Q 1/22

(57) ABSTRACT

A vehicle reverse gear intention signaling means. In one embodiment the invention relates to a signaling means (1) that anticipates the reverse gear maneuver, comprised by a key (2) installed on the dashboard (3) of the vehicle (4) which allows the driver, upon spotting a vacant parking space ahead, to previously activate the reverse gear intention signaling means warning the driver that follows immediately behind, on the same lane of the thoroughfare, that he/she intends to effect a reverse gear parking maneuver, avoiding the advancement of the vehicle that follows behind and freeing the space necessary for the realization of the maneuver with safety.

### CROSS REFERENCE TO RELATED APPLICATIONS

This is the national phase under 35 U.S.C. §371 of International Application No. PCT/IB2014/065660, filed on Oct. 28, 2014, which claims priority to and the benefit of Brazilian Patent Application No. 1020130289108, filed on Nov. 8, 2013, the entire disclosures of each of which are incorporated by reference herein.

### FIELD OF THE INVENTION

The field of application of the reverse gear intention signaling means is the automotive sector, more specifically relating to vehicles in transit in the urban area, however not limited thereto, the application thereof being suitable in any means of transport that uses the reverse gear for small maneuvers.

### BACKGROUND OF THE INVENTION

A parking maneuver is a maneuver performed to park a vehicle in alignment with other parked cars. The parked cars are provided in a straight line, parallel to the curb, with the fender of each automobile in front of the rear fender of the adjacent vehicle. The parking maneuver requires entering the available vacant space using the reverse gear.

All vehicles have basic safety items, each one according to the law in force in the country for which it was manufactured. One of the mandatory items in all countries is the reverse gear light. That identification of reverse gear consists in a white light which purpose consists in alerting the drivers of other vehicles, and also illuminate locations where lighting is poor, increasing the lighting at the maneuver location.

There currently exist products that provide an audible and luminous warning when the reverse gear is engaged, however such alert only occurs after the parking maneuver has begun, and notwithstanding that it is not a mandatory item, as its function is additional and commonly applied in heavy vehicles, as well as in buses, trucks, trailer trucks, among others.

In light vehicles, such as passenger vehicles, the need to perform the reverse parking maneuver in the middle of traffic entails an enormous difficulty, since we are unable to warn the other drivers about our intention to park, causing a serious hindrance to the flow of traffic and in some cases entailing the risk of accidents or the continuation of the forward travel of the following vehicle causing the impossibility of performance of the maneuver.

When that occurs, a greater problem occurs, since it is necessary to leave the space vacant and travel around the entire block to return to that previously desired space, where in the majority of cases the vacancy is already taken by another driver that was in the same condition of looking for a vacant parking space.

There already exist in the market intelligent vehicles that are able to automatically park and/or detect vacancies where the vehicle might be parked. However, for that purpose, the driver must warn the driver that follows behind him or her of his/her intention to park, otherwise the following driver proceeds forward and the intelligent automobile is unable to successfully complete the maneuver.

With the above-cited inconveniences in mind, the manufacturers that are most attentive to the market needs develop products that provide constructive simplicity, efficiency and safety for reverse gear maneuvers in the midst of traffic, in conformity with the focus of the instant patent application, such characteristics having been gaining space in the consumer market.

The current state of the art anticipates some patent documents that relate to the subject matter under consideration, such as MU 6700552-7 with the title “ALARME LUMINE-SONORO DE MARCHA À RÉ” [A REVERSE GEAR LUMINOUS-AUDIBLE ALARM] which refers to an alarm comprised by a bicolor front cover, a housing for two light bulbs, a printed circuit, a loudspeaker and a rear cover attached to the rear fender of the vehicle or any other that might be preferable.

In this case, the mentioned patent presents as its inventive concept a luminous and audible alarm to alert all those around it that the vehicle is in reverse gear, that is, that alarm is activated only when the gear is engaged, and it is not efficient to warn the drivers following behind regarding its intention to maneuver, incurring the same inconveniences cited above.

### SUMMARY OF THE INVENTION

The present patent of invention relates to a Vehicle reverse gear intention signaling means, particularly a signaling means that anticipates the reverse gear maneuver, comprised by an actuating circuit installed on the vehicle dashboard interlinked with the electrical circuit, which allows the driver, when spotting a vacant parking space ahead, to activate the signaling means to indicate the intention to reverse gears, previously warning the driver that follows behind him/her, at the same lane of the thoroughfare, that he/she intends to perform the parking maneuver, avoiding the progress of the vehicle that follows behind and freeing space for performing the maneuver with safety.

Aware of the state of the art, its faults and limitations, upon studies and researches the inventor created the Vehicle reverse gear intention signaling means in question, which in general lines, conceives a signaling means that anticipates the reverse gear maneuver, comprised by an actuating device installed on the dashboard of the vehicle, interlinked to the electrical circuit, which allows the driver, when the same spots a vacant parking space ahead, to activate the reverse gear intention signaling means, previously warning the driver following immediately behind, on the same lane of the thoroughfare, that he/she intends to perform a parking maneuver, avoiding that the vehicle that follows behind might continue to advance and freeing the space necessary to perform the maneuver with safety.

The vehicle reverse gear intention signaling means allows the driver to predict a situation that he/she will perform further along and warn the other drivers with anticipation that he/she intends to perform a reverse gear maneuver.

The vehicle reverse gear intention signaling means thus proposes that when the user sees a possibly vacant space to park his/her vehicle, he/she activates a command that will cause the reverse fear light of the vehicle to start blinking. In that manner, the driver that follows behind him/her identifies the intention of the driver in front to perform the reverse gear maneuver and avoids continuing to move forward when the first driver is parallel to the parked vehicles and initiating the maneuver.

In summary, the claimed reverse gear intention signaling means presents the following as its most preponderant advantages:
Provide anticipated warning of his/her intention to perform a reverse gear maneuver to the driver that follows immediately behind;
Warrants greater safety on performing the maneuver;
Avoids that the vehicle following behind continue to advance and thus hinder the successful parking in the vacancy found;
Allows fluidity of traffic without hindrances;
Avoids the loss of the parking space that would occurs if the driver following behind continued to advance thus preventing the parking maneuver;
Constructive simplicity;
Excellent cost-benefit relationship.

### BRIEF DESCRIPTION OF THE DRAWINGS

In the following, the invention is explained with reference to the attached drawings, wherein are represented, in an illustrative and non-limitative manner:

FIG. 1: Flow diagram of the functioning of the vehicle reverse gear intention signaling means;

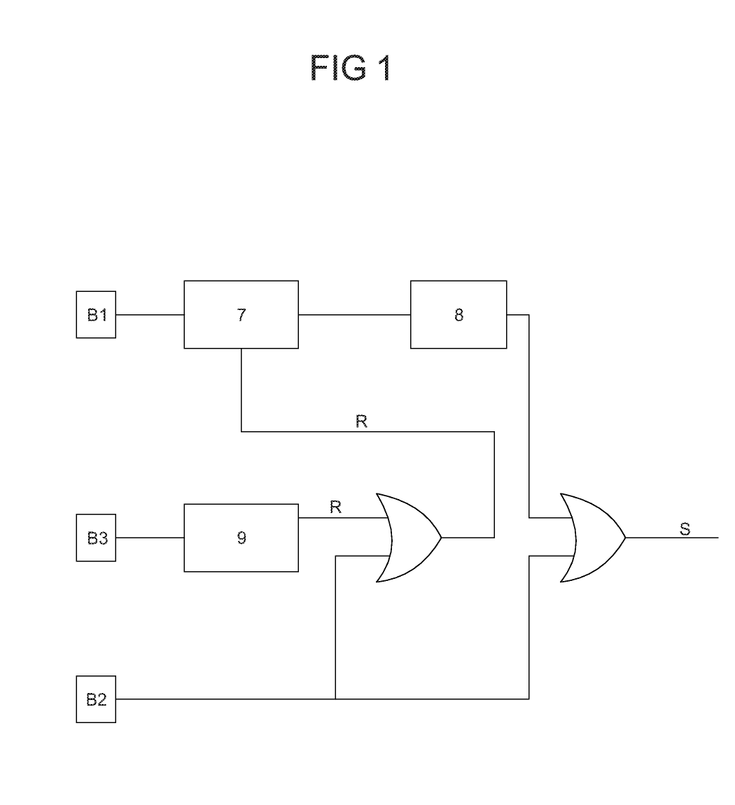

FIG. 2: Schematic view of the reverse gear intention signaling means, installed in a vehicle;

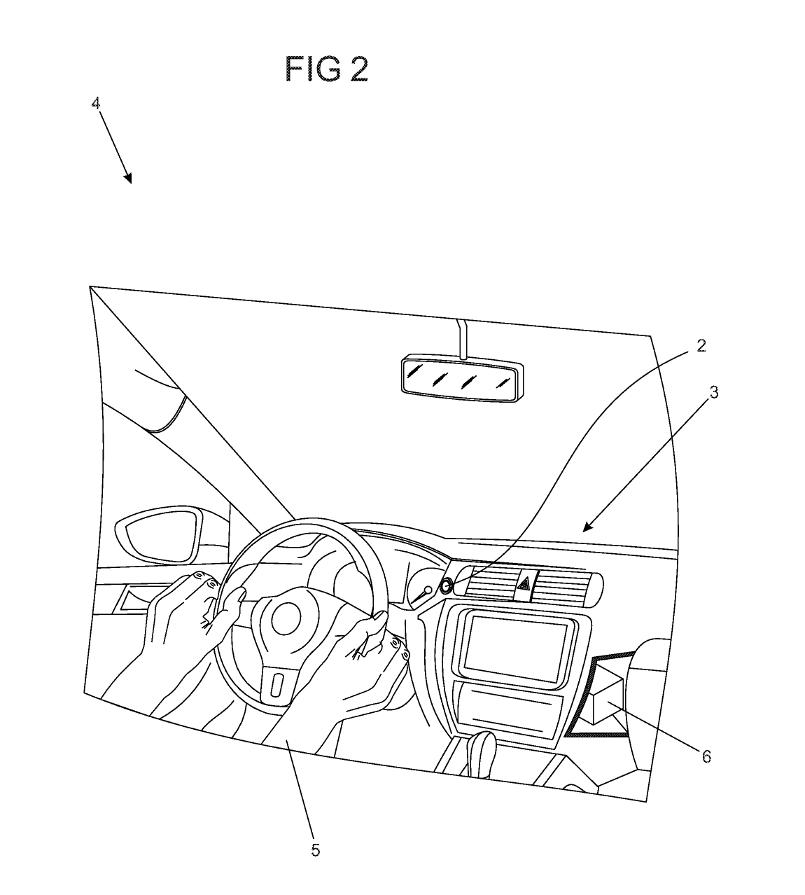

FIG. 3: Schematic view of the reverse gear intention signaling means, showing the use thereof.

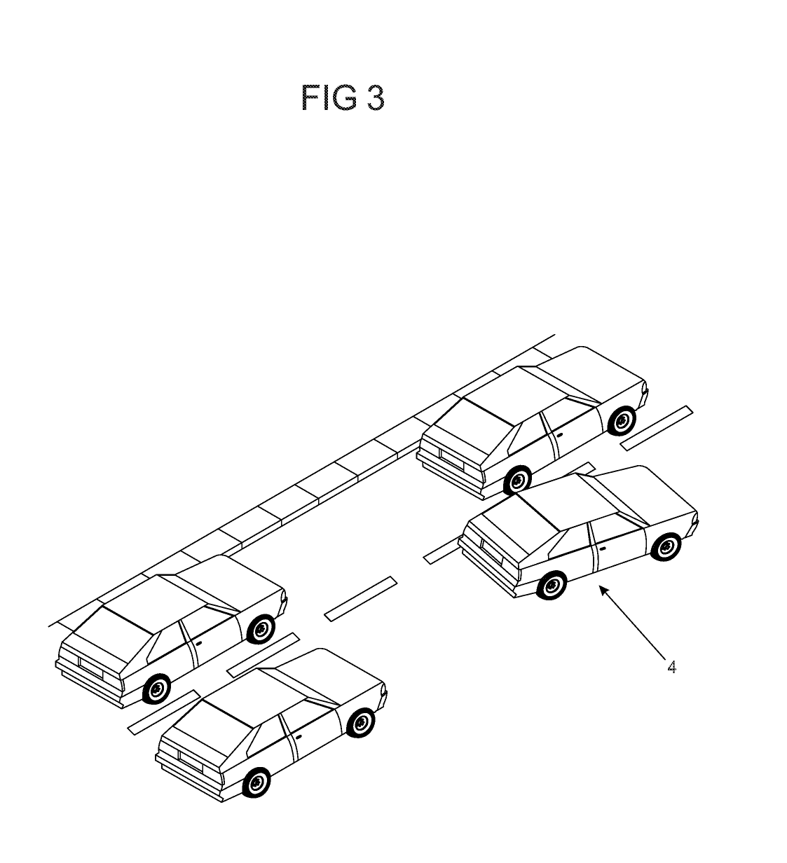

### DESCRIPTION OF A PREFERRED EMBODIMENT

The vehicle reverse gear intention signaling means, that constitutes the object of the instant application for a Patent of Invention, refers to a signaling device (1) provided with an actuating key (2) installed on the dashboard (3) of the vehicle (4) in a location easily accessible to the driver (5). That key (2) establishes contact with the command central (6) that contains the bistable element (7), the multi-vibrator (8), the speed detector (9) and the restart means (R) that will provide the luminous warning (S).

That signaling device (1) has various steps and all of these are based on the principle that the vehicle is in movement. Such steps are the following:

Step (B1)—Activate the Reverse Gear Intention Signaling Means and Subsequently Engage the Gear: on locating the parking space, there is activated the key (2) of the device (1) on the dashboard (3) and the reverse gear light will blink warning the driver that follows behind, and at the time when the reverse gear is engaged, that same light will stay constantly lit. When the driver disengages the reverse gear that light will be turned off.
Step (B2)—Activate the Reverse Gear Alert and Subsequently Deactivating the Same Manually: in this case there is activated the key (2) of the device (1) on the panel (3) and the reverse gear light starts to blink, however if the driver, for some motive, desists from the maneuver, is suffices to actuate the button (2) once again and the light will stop blinking and will be turned off.
Step (B3)—To Activate the Reverse Gear Alert and Leave Again with the Vehicle: there is activated the key (2) of the device (1) on the dashboard (3) starting the blinking of the reverse gear light, and the driver (5) with the vehicle desisting from making the reverse gear maneuver, and accelerating the vehicle (4), will make the command central (6) understand by means of the signal of rotation or speed that the driver (5) aborted the maneuver and the reverse gear light is automatically turned off.

Therefore, the present application for a patent of invention evidences novelty and inventive step due to the signaling means providing early warning to the driver following behind of the front driver intention of parking and avoids that the following driver might prevent the maneuver, which added to the industrial applicability thereof causes it to deserve the patent protection.

The claimed is:

1) A Vehicle reverse gear intention signaling means, wherein a signaling device (1) is provided with a key (2) installed on the dashboard (3) of the vehicle (4), interfacing with the command central (6) with a bistable element (7), a multivibrator (8) and a speed detector (9).

2) A Vehicle reverse gear intention signaling means, according to claim 1, wherein the signaling device can be installed in any automotive vehicle.
